(19) United States
(12) Patent Application Publication
(10) Pub. No.: US 2004/0126572 A1
(43) Pub. Date: Jul. 1, 2004

(54) Zirconium-containing metal oxide dispersions for recording media with improved ozone resistance

(75) Inventors: Michael D. Morris, Nashua, NH (US); Christopher A. Toles, Framingham, MA (US)

Correspondence Address: Michelle B. Lando, Cabot Corporation, Billerica Technical Center, 157 Concord Road, Billerica, MA, 01821-7001, US

(73) Assignee: Cabot Corporation, Boston, MA

(21) Appl. No.: 10/666,517

(22) Filed: Sep. 19, 2003

Related U.S. Application Data
(60) Provisional application No. 60/412,216, filed on Sep. 20, 2002.

(51) Int. Cl. B32B 5/16

(52) U.S. Cl. 428/328; 451/546; 451/41

(57) ABSTRACT

The invention provides an aqueous dispersion comprising fumed alumina particles, at least one zirconium compound, and water. The invention further provides a coating composition and a recording medium incorporating the inventive dispersion, as well as a method of preparing the recording medium.

### CROSS-REFERENCE TO RELATED PATENT APPLICATIONS

This patent application claims the benefit of U.S. Provisional Patent Application No. 60/412,216, filed Sep. 20, 2002.

### FIELD OF THE INVENTION

This invention pertains to aqueous dispersions of fumed alumina useful in the preparation of coating compositions and recording media.

### BACKGROUND OF THE INVENTION

The use of metal oxides in the preparation of recording media is well known in the art. Generally, a metal oxide is incorporated into a coating composition and applied to the surface of a substrate to produce a recording medium. While many metal oxides are useful in the production of recording media, alumina is particularly advantageous in that alumina particles naturally have a cationic surface (i.e., a positive zeta potential). Since the vast majority of ink dyes are anionic in nature, the cationic surface of alumina imparts superior dye-immobilizing properties to coatings derived therefrom. Moreover, alumina also imparts good ink absorption, good waterfastness, and good image smear resistance, in addition to superior gloss, smoothness, and brightness, to the coating.

Despite these advantages, the images printed on recording media incorporating alumina, as well as other prior recording media, exhibit less than desirable degrees of permanence (i.e., the images printed on the recording media begin to fade over time). Several attempts have been made to discover the cause of the fading and to increase the permanence of printed images; however, none of these attempts has proved to be entirely successful.

A need therefore exists for an aqueous dispersion and a coating composition useful in the preparation of recording media that exhibit improved image permanence. A need also exists for such recording media and methods for preparing the same. The invention provides such an aqueous dispersion, a coating composition, and a recording medium. These and other advantages of the invention, as well as additional inventive features, will be apparent from the description of the invention provided herein.

### BRIEF SUMMARY OF THE INVENTION

The invention provides an aqueous dispersion comprising fumed alumina particles, at least one zirconium compound, and water. The invention further provides a coating composition comprising the dispersion and at least one binder, as well as a recording medium comprising a substrate and the coating composition applied to at least a portion of the substrate. Lastly, the invention provides a method for making a recording medium comprising providing a substrate, providing the aforementioned coating composition, coating at least a portion of the substrate with the coating composition to provide a coated substrate, and drying the coated substrate to provide a recording medium.

### DETAILED DESCRIPTION OF THE INVENTION

The invention provides an aqueous dispersion comprising fumed alumina particles, at least one zirconium compound, and water. As utilized herein, the term “dispersion” means any suspension of solid particles (e.g., fumed alumina) in a liquid medium (e.g., water), wherein at least 95 wt. % (e.g., about 97 wt. % or about 99 wt. %) of the total solid particles in the liquid medium remain suspended in the liquid medium (i.e., are colloidally stable in that the particles do not settle to the bottom of a container) for at least about 24 hours when the suspension is allowed to stand at a temperature of about 25° C. following the preparation thereof.

Fumed alumina particles are produced by pyrogenic processes and have the chemical composition Al₂O₃. These particles, typically, are aggregate particles of smaller primary particles, which are held together by relatively strong cohesive forces, such that the aggregate particles are not broken down into primary particles when dispersed in a liquid (e.g., aqueous) medium. Aggregate fumed alumina particles may also form larger agglomerate particles, which are held together by relatively weak cohesive forces. Agglomerate particles usually are broken down into aggregate particles when dispersed in a liquid (e.g., aqueous) medium.

The source of the fumed alumina particles is not particularly limited. For example, the fumed alumina particles used in the invention may be provided in the form of a dry powder or a dispersion in a liquid medium. Suitable fumed alumina particles include, but are not limited to, those sold by Cabot Corporation under the trademarks Cab-O-Sil®) and Cab-O-Sperse®. Furthermore, the fumed alumina particles used in conjunction with the invention can be derived from more than one source.

The aqueous dispersion of the invention comprises fumed alumina particles in any suitable amount. Typically, the aqueous dispersion comprises fumed alumina particles in an amount of from about 1% to about 50% by weight (e.g., from about 5% to about 50% by weight, or from about 10% to about 30% by weight). Embodiments of the invention that are particularly useful include aqueous dispersions having a fumed alumina content of at least about 10% by weight (i.e., from about 10% to about 50% by weight), more preferably at least about 20% by weight (i.e., from about 20% to about 50% by weight), and most preferably at least about 30% by weight (i.e., from about 30% to about 50% by weight). In certain other embodiments, such as when a dispersion of maximum stability is desired, the aqueous dispersion preferably comprises less than about 35% by weight of fumed alumina (e.g., from about 5% to about 35% by weight), more preferably less than about 25% by weight (e.g., from about 5% to about 25% by weight), and most preferably less than about 15% by weight (e.g., from about 5% to about 15% by weight).

The fumed alumina particles used in conjunction with the invention can have any suitable particle size. For the purposes of the invention, the particle size of a fumed alumina particle is the aggregate particle size, which is a measure of the spherical diameter of the aggregate particle. Particle diameter can be determined by any suitable technique, for example, by a light scattering technique (e.g., using a Brookhaven 90Plus Particle Scanner, available from Brookhaven Instruments Corporation, Holtsville, N.Y.). In the context of the invention, the particle size of the fumed alumina may be optimized over a wide range to suit specific applications of the inventive aqueous dispersion (e.g., coating compositions). Typically, the average aggregate particle size (by number) of the fumed alumina particles is less than 1 μm. Preferred fumed alumina particles have an average aggregate particle size (by number) of about 400 nm or less (e.g., about 300 nm or less), more preferably about 200 nm or less (e.g., about 100-200 nm).

In certain preferred embodiments, at least about 80% (e.g., at least about 90%) or substantially all of the fumed alumina particles have diameters smaller than the mean diameter values set forth above. In other words, it is preferred that at least about 80% (e.g., at least about 90%) or substantially all of the particles have diameters of less than about 1 pm, more preferred that at least about 80% (e.g., at least about 90%) or substantially all of the particles have diameters of less than about 400 nm, still more preferred that at least about 80% (e.g., at least about 90%) or substantially all of the particles have diameters of less than about 300 mm, and most preferred that at least about 80% (e.g., at least about 90%) or substantially all of the particles have diameters of less than about 200 nm.

In other preferred embodiments, the mean diameter of the alumina particles is at least about 40 nm (e.g., particles having a mean diameter from about 40 nm to about 300 nm, more preferably from about 100 nm to about 200 nm, still more preferably from about 120 to about 190 run, and most preferably from about 140-180 nm (e.g., from about 150-170 nm)). In certain of these embodiments, at least about 80% (e.g., at least about 90%) or substantially all of the alumina particles have diameters of at least about 100 nm (e.g., from about 100 nm to about 200 nm, more preferably from about 120 to about 190 run, and most preferably from about 140-180 nm (e.g., from about 150-170 nm)).

The dispersion can comprise alumina particles having any suitable range of individual particle diameters, such as a relatively broad range or a relatively narrow range. The particles also can be monodispersed. The term “monodispersed” indicates that the individual particles have diameters that are substantially identical. For example, substantially all monodispersed 150 nm particles have diameters in the range of from about 140 nm to about 160 nm.

With respect to the primary particles that make up these fumed alumina aggregates, in certain embodiments of the invention, it is preferred that the primary particles have a mean diameter of less than about 100 nm (e.g., from about 1 nm to about 100 nm). More preferably, the primary particles have a mean diameter of less than about 80 nm (e.g., from about 1 nm to about 80 nm), even more preferably less than about 50 nm (e.g., from about 1 nm to about 50 nm), and most preferably less than about 40 nm (e.g., from about 5 nm to about 40 nm).

In certain of these embodiments it is preferred that at least about 80% (e.g., at least about 90%) or substantially all of the primary particles have diameters smaller than the mean diameter values set forth above. In other words, it is preferred that at least about 80% (e.g., at least about 90%) or substantially all of the primary particles have diameters of less than about 100 nm (e.g., from about 1 nm to about 100 nm), more preferred that at least about 80% (e.g., at least about 90%) or substantially all of the primary particles have diameters of less than about 80 nm (e.g., from about 1 nm to about 80 nm), even more preferred that at least about 80% (e.g., at least about 90%) or substantially all of the primary particles have diameters of less than about 50 nm (e.g., from about 1 nm to about 50 nm), and most preferred that at least about 80% (e.g., at least about 90%) or substantially all of the primary particles have diameters of less than about 40 nm (e.g., from about 5 nm to about 40 nm).

In certain of these embodiments it is preferred that at least about 80% (e.g., at least about 90%) or substantially all of the primary particles have diameters smaller than the mean diameter values set forth above. In other words, it is preferred that at least about 80% (e.g., at least about 90%) or substantially all of the primary particles have diameters of less than about 100 nm (e.g., from about 1 nm to about 100 nm), more preferred that at least about 80% (e.g., at least about 90%) or substantially all of the primary particles have diameters of less than about 80 nm (e.g., from about 1 nm to about 80 nm), even more preferred that at least about 80% (e.g., at least about 90%) or substantially all of the primary particles have diameters of less than about 50 nm (e.g., from about 1 nm to about 50 nm), and most preferred that at least about 80% (e.g., at least about 90%) or substantially all of the primary particles have diameters of less than about 40 nm (e.g., from about 5 nm to about 40 nm).

The fumed alumina particles used in the aqueous dispersion can have any suitable surface area. Typically, the surface area of the fumed alumina is determined by the method of S. Brunauer, P. H. Emmet, and I. Teller, J. Am. Chemical Society, 60, 309 (1938), which is commonly referred to as the BET method. Generally, the fumed alumina particles used in the inventive dispersion have a BET surface area of up to 400 m²/g. Preferably, the fumed alumina particles have a BET surface area of less than about 200 m²/g (e.g., about 30-200 m²/g), more preferably less than about 100 m²/g (e.g., about 40-100 m²/g), more preferably less than about 80 m²/g (e.g., about 30-80 m²/g), and most preferably less than about 60 m²/g (e.g., about 40-60 m²/g). In other preferred embodiments, the fumed alumina particles have a BET surface area of greater than about 30 m²/g, more preferably greater than about 40 m²/g.

The aqueous dispersion contains one or more zirconium compounds. The zirconium compound(s) used in conjunction with the invention can be any suitable zirconium compound. Preferably, the zirconium compound is a water-soluble zirconium compound. Examples of suitable water-soluble zirconium compounds include, but are not limited to, acetylacetone zirconium complexes, zirconium carbonate, zirconium sulfate, zirconium oxychloride, zirconium acetate, zirconium nitrate, zirconium hydroxide, ammonium zirconium carbonate, potassium zirconium carbonate, zirconium hydroxychloride, zirconium propionate, zirconium sulfate, zirconium phosphate, zirconium sodium phosphate, zirconium hexafluoride, and mixtures thereof. Most preferably, the water-soluble zirconium compound is zirconium hydroxychloride.

The amount of zirconium compound(s) used in conjunction with the invention can be conveniently expressed in terms of the equivalent weight of zirconium oxide. As used herein, the term equivalent weight refers to the amount of the zirconium compound(s) needed to produce one mol (123 g) of zirconium oxide (ZrO₂). Preferably, the total amount of the zirconium compound(s) present in the dispersion is sufficient to provide an equivalent weight ratio of zirconium oxide to fumed alumina of at least about 0.05 (e.g., about 0.05-0.6), more preferably a ratio of at least about 0.1 (e.g., about 0.1-0.3). In other preferred embodiments, the total amount of zirconium compound(s) in the dispersion is sufficient to provide an equivalent weight ratio of zirconium oxide to fumed alumina of less than about 0.6, more preferably less than about 0.3.

The amount of zirconium compound(s) present in the aqueous dispersion also can be expressed in terms of the percentage of the total weight of the dispersion. Preferably, the zirconium compound(s) comprises less than about 10% (e.g., about 0.1-10%), more preferably less than about 8% (e.g., about 2-8%), and most preferably less than about 6% (e.g., about 3-6%) by weight of the dispersion. In other preferred embodiments, the zirconium compound(s) comprises more than about 0.1%, more preferably more than about 2%, and most preferably greater than about 3% by weight of the dispersion.

As set forth above, a dispersion comprises particles suspended in a liquid medium. The inventive aqueous dispersion comprises water, preferably deionized water. The aqueous dispersion also can comprise any number of suitable water-miscible liquids, such as one or more water-miscible alcohols (e.g., methanol, ethanol, etc.) or ketones (e.g., acetone) in addition to water.

The dispersion can have any suitable pH at which the dispersion is stable. Typically, the pH of the dispersion is less than about 7 (e.g., about 1-7), preferably less than about 6 (e.g., about 2-6), more preferably less than about 5 (e.g., about 2-5). In other embodiments, the pH of the dispersion is greater than about 1, preferably greater than about 2, and more preferably greater than about 3. The pH of the dispersion can be adjusted using any suitable method, such as via the addition of an acid (e.g., mineral acid, acidic cation exchange resin, etc.) or a base (e.g., an alkali metal hydroxide, basic anion exchange resin, etc.).

While the dispersion can contain other additives, it is preferred that the dispersion consists essentially of, or consists of, fumed alumina particles, at least one zirconium compound, and water. The phrase “consists essentially of,” as used herein to describe the inventive dispersion, excludes any component that would negatively impact the colloidal stability of the aqueous dispersion (e.g., any component that would cause the fumed alumina particles to settle out of the dispersion).

The dispersion can be prepared by any suitable method. Preferably, the dispersion is prepared by a method comprising (a) mixing fumed alumina particles with an aqueous vehicle under high shear conditions to form a mixture of fumed alumina particles, such that the mixture does not coagulate, and (b) adding at least one zirconium compound to the mixture of (a), so as to form a dispersion of fumed alumina particles, at least one zirconium compound, and water. Mixing under high shear conditions provides an even distribution of the components of the dispersion, thereby forming a substantially uniform or homogeneous mixture of the components. Mixing under high shear conditions also can improve the rheology of the dispersion and can increase the strength and uniformity of any final article prepared from the dispersion. High shear mixers are described in U.S. Pat. Nos. 4,225,247, 4,552,463, 4,889,428, 4,944,595, and 5,061,319.

In a related aspect, the invention provides a coating composition comprising the aqueous dispersion of fumed alumina particles and at least one zirconium compound, as described herein, and at least one binder. Any suitable binder(s) can be used in accordance with the coating composition of the invention. Suitable binders include, but are not limited to, cellulose esters, cellulose ethers, vinyl polymers, acrylic polymers, polyesters, polycarbonate polymers, polyamides, polyimides, epoxy polymers, phenolic polymers, polyolefins, copolymers thereof, and mixtures thereof. A preferred binder is polyvinyl alcohol.

The binder(s) can be present in the coating composition in any suitable amount. Typically, the total amount of binder(s) in the coating composition is less than about 20% (e.g., about 0.1-20%), preferably less than about 15% (e.g., about 0.5-15%), more preferably less than about 10% (e.g., about 1-10%) by weight of the coating composition. In other embodiments, the total amount of binder(s) in the coating composition is greater than about 0.1%, preferably greater than about 0.5%, more preferably greater than about 1% by weight of the coating composition. The desired amount of binder(s) in the aqueous dispersion depends on the particular binder(s). For example, the optimum amount of polyvinyl alcohol in the coating composition may be different from the optimum amount of polyvinyl pyrrolidone in the coating composition.

The coating composition can be prepared by any suitable method. Preferably, the coating composition is prepared by combining an aqueous dispersion as described herein (e.g., an aqueous dispersion comprising fumed alumina, at least one zirconium compound, and water) with at least one binder to produce the coating composition. The pH of the coating composition can be adjusted at any stage during its preparation so as to prevent flocculation and/or coagulation of the coating composition or any component used to produce the coating composition (e.g., a dispersion of fumed alumina particles). For example, the pH can be adjusted during the preparation of the dispersion before mixing the dispersion with the at least one binder. The pH also can be adjusted after the dispersion is mixed with the at least one binder (i.e., after forming the coating composition). In any case, it is preferred that the pH of the coating composition be about 1-7 (e.g., about 2-6). In certain embodiments, such as when maximum dispersion stability is desired, it is preferred that the pH of the coating composition be about 2-5, more preferably about 2-4. The pH can be adjusted using any suitable method, such as via the addition of an acid (e.g., mineral acid, acidic cation exchange resin, etc.) or a base (e.g., an alkali metal hydroxide, basic anion exchange resin, etc.).

The coating composition of the invention also can comprise one or more other additives, such as surfactants (e.g., cationic surfactants, anionic surfactants such as long-chain alkylbenzene sulfonate salts and long-chain, preferably branched chain, alkylsulfosuccinate esters, nonionic surfactants such as polyalkylene oxide ethers of long-chain, preferably branched-chain alkyl group-containing phenols and polyalkylene oxide ethers of long-chain alkyl alcohols, and fluorinated surfactants), hardeners (e.g., active halogen compounds, vinylsulfone compounds, aziridine compounds, epoxy compounds, acryloyl compounds, isocyanate compounds, etc.), pigment dispersants, thickeners (e.g., carboxymethyl cellulose (CMC)), flowability improvers, antifoamers (e.g., octyl alcohol, silicone-based antifoamers, etc.), foam inhibitors, releasing agents, foaming agents, penetrants, coloring dyes, coloring pigments, whiteners (e.g., fluorescent whiteners), preservatives (e.g., p-hydroxybenzoate ester compounds, benzisothiazolone compounds, isothiazolone compounds, etc.), antifingal agents, yellowing inhibitors (e.g., sodium hydroxymethanesulfonate, sodium p-toluenesulfinate, etc.), ultraviolet absorbers (e.g., benzotriazole compounds having an hydroxy-dialkylphenyl group at the 2-position), antioxidants (e.g., sterically hindered phenol compounds), antistatic agents, pH regulators (e.g., sodium hydroxide, sodium carbonate, sulfuric acid, hydrochloric acid, phosphoric acid, citric acid, etc.), water-resisting agents, wet strengthening agents, and dry strengthening agents. In addition to these additives, the coating composition also can comprise a mordant. Suitable mordants include, for example, poly(ethyleneimine), poly(vinylbenzyl trimethylammonium chloride), poly(diallyldimethyl ammonium chloride), and mixtures thereof.

The invention further provides a recording medium comprising a substrate and a coating composition as described herein (e.g., a coating composition comprising at least one binder and an aqueous dispersion of fumed alumina particles, at least one zirconium compound, and water) applied to at least a portion of the substrate. The substrate used in conjunction with the invention can be either transparent or opaque, and can be made of any suitable material. Examples of such materials include, but are not limited to, polyesters (e.g., poly(ethylene terephthalate)), diacetate resins, triacetate resins, acrylic resins, polycarbonate resins, polyvinyl chloride resins, polyimide resins, cellophane and celluloid, glass sheets, metal sheets, plastic sheets, paper (e.g., cellulose or synthetic paper), photo-base material (e.g., paper coated with polyethylene or baryte), pigment-containing opaque films, and foamed films. Preferably, the substrate comprises a polymer film, paper, or a photo-base material. When the substrate comprises a polymer film, the polymer film is preferably selected from the group consisting of poly(ethylene terephthalate), polyvinyl chloride, or mixtures thereof. When the substrate comprises a paper, the paper is preferably cellulose paper, and when the substrate comprises a photo-base material, preferably the photo-base material is coated with at least one material selected from the group consisting of polyethylene, baryte, and mixtures thereof.

The properties of the inventive recording medium promote high image quality when used in the vast majority of printing applications. Any suitable printing method can be used to apply an image to the inventive recording medium. Such printing methods include, but are not limited to gravure, letterpress, lithography (e.g., offset lithography), ink-jet, and printing with hand-held implements (e.g., pens), with ink-jet printing being preferred.

Images printed on the recording medium of the invention exhibit enhanced permanence relative to images printed on similar recording media (i.e., recording media comprising the same substrate, but which do not comprise fumed alumina particles and at least one zirconium compound). While not wishing to be bound to any particular theory, it is believed that the fading associated with earlier recording media is due to an interaction between ozone and the dyes printed on the surface of the recording media. In particular, it is believed that ozone accelerates the degradation of a dye applied to the surface of these recording media. It is believed that the zirconium compound(s) present in the coating on the inventive recording medium interacts with ozone at the surface of the recording medium, thereby reducing the number of ozone-dye interactions. It is further believed that this reduction decreases the rate of degradation of any dye printed on the surface of the recording medium, thereby contributing to the higher degree of image permanence exhibited by the recording medium of the invention as compared to earlier recording media. More specifically, the recording medium of the invention exhibits enhanced resistance to ozone-mediated degradation of a dye printed on the recording medium as compared to the same recording medium that does not comprise fumed alumina particles and at least one zirconium compound.

The recording medium described herein can be prepared in accordance with the invention by a method comprising (a) providing a substrate, (b) providing a coating composition as described herein (e.g., a coating composition comprising at least one binder and an aqueous dispersion of fumed alumina particles, at least one zirconium compound, and water), (c) coating at least a portion of the substrate with the coating composition to provide a coated substrate, and (d) drying the coated substrate to provide a recording medium. Furthermore, the coating composition may be repeatedly applied to the substrate to provide a recording medium having a coating with a desired thickness.

Any suitable method can be used to coat a portion of the substrate with the inventive coating composition. Suitable methods include, but are not limited to, roll coating, blade coating, air knife coating, rod coating (e.g., using a Meyer rod or the like), bar coating, cast coating, gate roll coating, wire bar coating, short-dowel coating, slide hopper coating, curtain coating, flexographic coating, gravure coating, Komma coating, size press coating in the manner of on- or off-machine, and die coating, with rapid, inexpensive methods such as rod coating and blade coating being preferred. The coating applied to the substrate can be of any suitable thickness. In particular, the coating is preferably less than about 50 μm in thickness (e.g., about 1-50 μm), more preferably less than about 40 μm (e.g., about 5-40 μm), and most preferably less than about 30 μm (e.g., about 10-30 μm). The coating also preferably is greater than about 1 μm, more preferably greater than about 5 μm, most preferably greater than about 10 μm in thickness.

After application of the coating composition to the substrate, the coated substrate can be dried using any suitable method or combination of methods to provide the recording medium. Suitable drying methods include, but are not limited to, air or convection drying (e.g., linear tunnel drying, arch drying, air-loop drying, sine curve air float drying, etc.), contact or conduction drying, and radiant-energy drying (e.g., infrared drying and microwave drying).

The invention also provides a method for improving the resistance of a recording medium to ozone-mediated degradation comprising coating at least a portion of a substrate with a coating composition as described herein. The substrate can be any suitable substrate, such as those described herein with respect to the inventive recording medium. The substrate can be coated by any suitable method, and the coating applied to the substrate can be of any suitable thickness. Examples of suitable coating methods and coating thicknesses include, but are not limited to, those described herein with respect to the method for preparing a recording medium. Following application of the coating composition to the substrate, the coated substrate may be dried using any suitable method or combination of methods, such as those described herein with respect to the method for preparing a recording medium.

The following examples further illustrate the invention but, of course, should not be construed as in any way limiting its scope.

### EXAMPLE 1

This example illustrates the preparation of an aqueous dispersion according to the invention. A Waring blender (1l capacity) was charged with 0.5 g of an aqueous hydrochloric acid solution having a pH of 1.0. The blender was then turned on, and 114 g of fumed alumina particles (Cab-O-Sil® CT-1300 fumed alumina, available from Cabot Corporation) was slowly added to the blender over 10 minutes. Next, 414 g of distilled water having a pH of 5.5 was added to produce a final concentration of fumed alumina particles of approximately 21% by weight. The resulting suspension was rapidly mixed for an additional 20 minutes. Lastly, 100 g of an aqueous zirconium hydroxychloride solution (20% ZrO₂ equivalent available from MEL Chemicals) was added to the blender, and the mixing was stopped.

The product was a stable, aqueous dispersion comprising fumed alumina particles, a zirconium compound (i.e., zirconium hydroxychloride), and water.

### EXAMPLE 2

This example illustrates the preparation of an aqueous dispersion according to the invention. An aqueous dispersion was prepared according to the same general procedure set forth in Example 1, except the total amount of fumed alumina particles was 94 g. Also, the total amount of distilled water used in preparing the dispersion was 218 g, which resulted in a fumed alumina concentration of approximately 30% by weight. Lastly, 200 g of the zirconium hydroxychloride solution were added to the suspension.

The product was a stable, aqueous dispersion comprising fumed alumina particles, a zirconium compound (i.e., zirconium hydroxychloride), and water.

### COMPARATIVE EXAMPLE 1

An aqueous dispersion was prepared in accordance with the procedure set forth in Example 1, except no zirconium compound was added to the suspension. Furthermore, the total amounts of fumed alumina and distilled water used in preparing the dispersion were 300 g and 450 g, respectively.

### EXAMPLE 4

This example illustrates the preparation of a coating composition according to the invention. In this example, 100 g of the aqueous dispersion described in Example 1 was combined with 11.7 g of a polyvinyl alcohol binder (Celvol™203 polyvinyl alcohol, 30% aqueous solution available from Celanese Chemicals) to yield a dry weight ratio of alumina to binder of approximately 6:1. Then, 0.8 g of a surfactant (Surfactant 10G, 10% solution available from Arch Chemicals, Inc.) was added, and the mixture was shaken to produce a uniform mixture.

The product was a coating composition comprising the aqueous dispersion of Example 1 and a binder (i.e., polyvinyl alcohol).

### EXAMPLE 5

This example illustrates the preparation of a coating composition according to the invention. In this example, 100 g of the aqueous dispersion described in Example 2 was combined with 14.4 g of a polyvinyl alcohol binder (Celvol™ 203 polyvinyl alcohol, 30% aqueous solution available from Celanese Chemicals) to yield a dry weight ratio of oxide to binder of approximately 6:1. Then, 0.8 g of a surfactant (Surfactant 10G, 10% solution available from Arch Chemicals, Inc.) was added, and the mixture was shaken to produce a uniform composition.

The product was a coating composition comprising the aqueous dispersion of Example 2 and a binder (i.e., polyvinyl alcohol).

### COMPARATIVE EXAMPLE 2

A coating composition was prepared by combining the aqueous dispersion described in Comparative Example 1 with 22.2 g of a polyvinyl alcohol binder (Celvol™ 203 polyvinyl alcohol, 30% aqueous solution available from Celanese Chemicals) to yield a dry weight ratio of oxide to binder of approximately 6:1. Then, 0.9 g of a surfactant (Surfactant 10G, 10% solution available from Arch Chemicals, Inc.) was added, and the mixture was shaken to produce a uniform mixture.

### EXAMPLE 6

This example illustrates the preparation of a recording medium according to the invention. An unsized paper substrate was coated with the coating composition of Example 4 using a #24 Meyer rod. The coated substrate was dried at 35° C. under ambient humidity. The dry weight of the resultant coating was approximately 9-14 g/m².

The resulting recording medium had a coating comprising a binder (i.e., polyvinyl alcohol) and an aqueous dispersion comprising fumed alumina particles, a zirconium compound (i.e., zirconium hydroxychloride), and water.

### EXAMPLE 7

This example illustrates the preparation of a recording medium according to the invention. An unsized paper substrate was coated with the coating composition of Example 5 using a #24 Meyer rod. The coated substrate was dried at 35° C. under ambient humidity. The dry weight of the resultant coating was approximately 9-14 g/m².

The resulting recording medium had a coating comprising a binder (i.e., polyvinyl alcohol) and an aqueous dispersion comprising fumed alumina particles, a zirconium compound (i.e., zirconium hydroxychloride), and water.

### COMPARATIVE EXAMPLE 3

A recording medium was prepared by coating an unsized paper substrate with the coating composition of Comparative Example 2 using a #24 Meyer rod. The coated substrate was dried at 35° C. under ambient humidity. The dry weight of the resultant coating was approximately 9-14 g/m².

### EXAMPLE 8

This example illustrates the improved resistance to ozone-mediated degradation of images printed on the recording media of the invention as compared to other recording media.

In this example, the recording media of Example 6, Example 7, and Comparative Example 3, as well as a commercially available porous, glossy photo paper (Canon PhotoPro photo paper, manufactured by Canon, Inc.), were equilibrated to ambient temperature and humidity. Next, the recording media were printed with a test pattern on a Canon BJC 8200 ink-jet printer using the ink-set provided by the manufacturer. The test pattern printed on each recording medium consisted of blocks of cyan, magenta, yellow, and black. After printing, the recording media were dried under ambient conditions.

Once the printed recording media had dried, each block of the test pattern was analyzed by colorimetry (using an X-Rite 938 Spectrodensitometer) to determine its respective L*, a*, and b* values. As is well known to those of skill the art, the L*, a*, and b* values are used in the CIE L*a*b* Color Space to order or describe colors. More specifically, the L* value is the lightness coordinate, which is a measure of the color along a continuum running from black to white. The a* value is the red-green coordinate, which is a measure of the color along a continuum running from red to green, and the b* value is the yellow-blue coordinate, which is a measure of the color along a continuum running from yellow to blue.

Following measurement of the initial L*, a*, and b* values of the test pattern printed on the recording media, the ozone resistance of the printed recording media was tested by exposing each of the samples to an atmosphere containing 1 part per million (ppm) ozone for 24 hours at 25° C. and 50% relative humidity. Then, each block of the test pattern was again analyzed to determine its respective L*, a*, and b* values. Using these L*, a*, and b* values, ΔE (i.e., the fade) was calculated using the following equation:

ΔE=\sqrt{(L*₂−L*₁)²+(a*₂−a*₁)²+(b*₂−b*₁)²}

In the equation, L*₂, a*₂, and b*₂ are the measured values of the test pattern after exposure to the ozone-containing atmosphere, and L*₁, a*₁, and b*₁ are the measured values of the test pattern before exposure to the ozone-containing atmosphere. A lower ΔE indicates less change (i.e., fade) in the overall color of the test patch. The ΔE values for each recording medium are set forth in Table 1.

TABLE 1

| | |
|---|---|
| Recording | ΔE (in %) |

| Medium | Yellow | Magenta | Cyan | Black |
|---|---|---|---|---|
| Example 6 | 2 | 7 | 17 | 7 |
| Example 7 | 4 | 8 | 20 | 5 |
| Comparative | 9 | 11 | 22 | 32 |
| Example 3 | | | | |
| Canon PhotoPro | 25 | 31 | 34 | 49 |
| photo paper | | | | |

The results of this comparison demonstrate the increased resistance to ozone-mediated degradation exhibited by the recording media of the invention relative to recording media that do not comprise fumed alumina particles and at least one zirconium compound.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An aqueous dispersion comprising fumed alumina particles, at least one zirconium compound, and water.

2. The aqueous dispersion of claim 1, wherein the fumed alumina particles have an average aggregate particle size (by number) of about 400 nm or less.

3. The aqueous dispersion of claim 2, wherein the fumed alumina particles have an average aggregate particle size (by number) of about 100-200 nm.

4. The aqueous dispersion of claim 1, wherein the fumed alumina particles have a BET surface area of about 30-200 m²/g.

5. The aqueous dispersion of claim 4, wherein the fumed alumina particles have a BET surface area of about 40-100 m²/g.

6. The aqueous dispersion of claim 1, wherein the zirconium compound is a water-soluble zirconium compound selected from the group consisting of acetylacetone zirconium complexes, zirconium carbonate, zirconium sulfate, zirconium oxychloride, zirconium acetate, zirconium nitrate, zirconium hydroxide, ammonium zirconium carbonate, potassium zirconium carbonate, zirconium hydroxychloride, zirconium propionate, zirconium sulfate, zirconium phosphate, zirconium sodium phosphate, zirconium hexafluoride, and a mixtures thereof.

7. The aqueous dispersion of claim 6, wherein the water-soluble zirconium compound is zirconium hydroxychloride.

8. The aqueous dispersion of claim 6, wherein the total amount of the zirconium compound in the dispersion is sufficient to provide an equivalent weight ratio of zirconium oxide to fumed alumina of at least about 0.05.

9. The aqueous dispersion of claim 8, wherein the total amount of the zirconium compound in the dispersion is sufficient to provide an equivalent weight ratio of zirconium oxide to fumed alumina of about 0.05-0.6.

10. The aqueous dispersion of claim 8, wherein the total amount of the zirconium compound in the dispersion is sufficient to provide an equivalent weight ratio of zirconium oxide to alumina of about 0.1-0.3.

11. The aqueous dispersion of claim 1, wherein the pH of the dispersion is about 1-7.

12. The aqueous dispersion of claim 11, wherein the pH of the dispersion is about 2-6.

13. The aqueous dispersion of claim 12, wherein the pH of the dispersion is about 2-5.

14. The aqueous dispersion of claim 1, wherein
(a) the fumed alumina particles have an average aggregate particle size (by number) of about 400 nm or less,
(b) the fumed alumina particles have a BET surface area of about 30-200 m²/g,
(c) the zirconium compound is a water-soluble zirconium compound selected from the group consisting of acetylacetone zirconium complexes, zirconium carbonate, zirconium sulfate, zirconium oxychloride, zirconium acetate, zirconium nitrate, zirconium hydroxide, ammonium zirconium carbonate, potassium zirconium carbonate, zirconium hydroxychloride, zirconium propionate, zirconium sulfate, zirconium phosphate, zirconium sodium phosphate, zirconium hexafluoride, and a mixtures thereof,
(d) the total amount of the zirconium compound in the dispersion is sufficient to provide an equivalent weight ratio of zirconium oxide to fumed alumina of at least about 0.05, and
(e) the pH of the dispersion is about 1-7.

15. The aqueous dispersion of claim 14, wherein the water-soluble zirconium compound is zirconium hydroxychloride.

16. The aqueous dispersion of claim 15, wherein the total amount of the zirconium compound in the dispersion is sufficient to provide an equivalent weight ratio of zirconium oxide to fumed alumina of about 0.05-0.6.

17. The aqueous dispersion of claim 16, wherein the fumed alumina particles have an average aggregate particle size (by number) of about 100-200 μm, the fumed alumina particles have a BET surface area of about 40-100 m²/g, the total amount of the zirconium compound in the dispersion is sufficient to provide an equivalent weight ratio of zirconium oxide to alumina of about 0.1-0.3, and the pH of the dispersion is about 2-5.

18. A coating composition comprising the dispersion of claim 1 and at least one binder.

19. The coating composition of claim 18, wherein the binder is selected from the group consisting of cellulose esters, cellulose ethers, vinyl polymers, acrylic polymers, polyesters, polycarbonate polymers, polyamides, polyimides, epoxy polymers, phenolic polymers, polyolefins, copolymers thereof, and a mixture thereof.

20. The coating composition of claim 18, wherein the binder is a polyvinyl alcohol.

21. The coating composition of claim 18, wherein the total amount of binder in the coating composition is about 0.5-15% by weight.

22. The coating composition of claim 21, wherein the total amount of binder in the coating composition is about 1-10% by weight.

23. A recording medium comprising a substrate and the coating composition of claim 1 applied to at least a portion of the substrate.

24. The recording medium of claim 23, wherein the substrate is paper.

25. The recording medium of claim 24, wherein the recording medium exhibits enhanced resistance to ozone-mediated degradation of a dye printed on the recording medium as compared to the same recording medium that does not comprise fumed alumina particles and at least one zirconium compound.

26. A method for preparing a recording medium comprising
(a) providing a substrate,
(b) providing a coating composition of claim 18,
(c) coating at least a portion of the substrate with the coating composition to provide a coated substrate, and
(d) drying the coated substrate to provide a recording medium.

27. The method of claim 26, wherein the substrate is paper.

28. The method of claim 27, wherein the recording medium exhibits enhanced resistance to ozone-mediated degradation of a dye printed on the recording medium as compared to the same recording medium that does not comprise fumed alumina particles and at least one zirconium compound.

29. A method for improving the resistance of a recording medium to ozone-mediated degradation comprising coating at least a portion of a substrate with the coating composition of claim 18.
